(19) United States
(12) Patent Application Publication
(10) Pub. No.: US 2012/0163487 A1
(43) Pub. Date: Jun. 28, 2012

(54) BASE STATION AND FEEDBACK INFORMATION CONTROL METHOD IN RADIO COMMUNICATION SYSTEM

(75) Inventors: Kenji KOYANAGI, Minato-ku (JP); Naoto ISHII, Minato-ku (JP)

(73) Assignee: NEC CORPORATION, Tokyo (JP)

(21) Appl. No.: 13/336,185

(22) Filed: Dec. 23, 2011

(30) Foreign Application Priority Data
Dec. 27, 2010 (JP) 2010-289240

(51) Int. Cl. H04B 7/02

(52) U.S. Cl. 375/267

(57) ABSTRACT

A base station includes: a subset information generation section which selects M precoding matrices from among N precoding matrices and sets the M precoding matrices as a precoding matrix subset; a transmission section which transmits the precoding matrix subset to a radio communication device; and a reception section which receives feedback information from a radio communication device that is generated by the radio communication device, wherein the feedback information includes information about at least one precoding matrix which is selected from the precoding matrix subset based on reception quality at the radio communication device.

### INCORPORATION BY REFERENCE

This application is based upon and claims the benefit of priority from Japanese Patent Application No. 2010-289240, filed on Dec. 27, 2010, the disclosure of which is incorporated herein in its entirety by reference.

### BACKGROUND

The present application relates to a radio communication system and, more particularly, to a base station and a feedback information control method for the same in a multiuser MIMO (Multiuser Multiple Input Multiple Output; hereinafter, abbreviated to MU-MIMO) environment.

In the case where MU-MIMO, which enables a base station to perform radio communications with a plurality of mobile stations at the same time by using the same frequency, is applied to downlinks, the base station performs antenna directivity control so as to prevent the simultaneously transmitted signals destined for a plurality of mobile stations from interfering with each other. The antenna directivity is formed by multiplying transmission signals by a precoding matrix, and the interference between mobile stations can be reduced by changing precoding matrices. For the precoding matrices of 3GPP (3rd Generation Partnership Project) LTE (Long Term Evolution), a plurality of predetermined matrix sets are standardized as a codebook, and a precoding matrix is selected from the codebook. When the number of transmission antennas is two and four, the number of matrices in the codebook is four and sixteen, respectively (see 3GPP, TS 36.211 (v9.0.0), “Physical Channel and Modulation”, December 2009; hereinafter referred to as “NPL1”).

Precoding is performed based on feedback information from mobile stations. As an example of notifying the feedback information in MU-MIMO, there has been proposed a method in which a mobile station is made to feed back PMI (Precoding Matrix Indicator) and BCI (Best Companion Indicator) (see R1-090777 Alcatel-Lucent, 3GPP RAN WG1 #56 Athen, 2009; hereinafter referred to as “NPL2”). PMI indicates a precoding matrix with which the reception quality at a mobile station is the highest, and BCI indicates a precoding matrix with which the reception quality at a mobile station is the lowest. PMI and BCI are selected from among all matrices included in the codebook, and the codebook index numbers of the selected precoding matrices are notified.

As shown in FIG. 1, it is assumed that a base station 10 receives PMI and BCI from a plurality of mobile stations #1, #j, and #k respectively and that the codebook index (number) of BCI#1 at the mobile station #1 is the same as the codebook indexes of PMI#j and PMI#K at the other mobile stations #j and #k with which MU-MIMO is performed. In this case, since BCI#1 is the number of the precoding matrix with which the reception quality at the mobile station #1 is the lowest, the interference within a cell received by the mobile station #1 at the same time using the same frequency resource can be reduced to the lowest level if the same precoding matrix as BCI#1 is used. By utilizing this characteristic, it is possible to group mobile stations with which MU-MIMO is performed so that PMI and BCI of a mobile station are the same as BCI and PMI of another station, respectively. This grouping makes it possible that the interference between mobile stations is minimized while the desired signal power at each station is maximized.

However, as described in NPL2, for the PMI and BCI-based grouping, PMI and BCI of a mobile station need to agree with BCI and PMI of another mobile station, respectively, as described above. Accordingly, when BCI of a mobile station does not agree with PMI of another mobile station, that is, when BCI of a mobile station is not fed back as PMI of another mobile station, the mobile station that has reported this BCI cannot be included in the group. The effect of increased throughput attributable to MU-MIMO cannot be obtained.

Accordingly, an illustrative embodiment provides a base station and a feedback information control method for the same that can achieve an increase in throughput attributable to MU-MIMO.

### SUMMARY

According to certain illustrative embodiments, a feedback information control method includes the operations of: selecting M precoding matrices from a predetermined number (N) of precoding matrices to set the M precoding matrices as a precoding matrix subset, wherein N is an integer equal to or greater than 2 and M is an integer equal to or greater than 1 and equal to or smaller than N; transmitting the precoding matrix subset to a radio communication device; and receiving, at a base station, feedback information from the radio communication device, wherein the feedback information includes information about at least one precoding matrix which is selected from the precoding matrix subset based on reception quality at the radio communication device.

According to certain illustrative embodiments, a base station includes: a subset information generation section which selects M precoding matrices from a predetermined number (N) of precoding matrices to set the M precoding matrices as a precoding matrix subset, wherein N is an integer equal to or greater than 2 and M is an integer equal to or greater than 1 and equal to or smaller than N; a transmission section which transmits the precoding matrix subset to a radio communication device; and a reception section which receives feedback information from the radio communication device, wherein the feedback information includes information about at least one precoding matrix which is selected from the precoding matrix subset based on reception quality at the radio communication device.

According to certain illustrative embodiments, it is possible to increase the throughput of a MU-MIMO system.

### BRIEF DESCRIPTION OF THE DRAWINGS

FIG. 1 is a network structure diagram showing an example of a mobile communication system to describe a related art.

FIG. 2 is a block diagram showing a functional configuration of a base station according to a first illustrative embodiment.

FIG. 3 is a block diagram showing a functional configuration of a mobile station according to the first illustrative embodiment.

FIG. 4 is a sequence diagram schematically showing a feedback information control method according to the first illustrative embodiment.

FIG. 5 is a flowchart showing feedback information control operation at the base station shown in FIG. 4.

FIG. 6 is a block diagram showing a functional configuration of a base station according to a second illustrative embodiment.

FIG. 7 is a flowchart showing feedback information control operation at the base station shown in FIG. 6.

FIG. 8 is a flowchart showing a modification example of the feedback information control operation at the base station shown in FIG. 6.

FIG. 9 is a block diagram showing a functional configuration of a base station according to a third illustrative embodiment.

FIG. 10 is a sequence diagram schematically showing a feedback information control method according to the third illustrative embodiment.

FIG. 11 is a flowchart showing feedback information control operation at the base station shown in FIG. 9.

FIG. 12 is a graph showing concrete effects of the feedback information control according to the third illustrative embodiment.

FIG. 13 is a diagram giving some figures showing concrete effects of the feedback information control according to the third illustrative embodiment.

FIG. 14 is a block diagram showing a functional configuration of a base station according to a fourth illustrative embodiment.

FIG. 15 is a flowchart showing feedback information control operation at the base station shown in FIG. 14.

FIG. 16 is a block diagram showing a functional configuration of a base station according to a fifth illustrative embodiment.

FIG. 17 is a flowchart showing feedback information control operation at the base station shown in FIG. 16.

### DETAILED DESCRIPTION

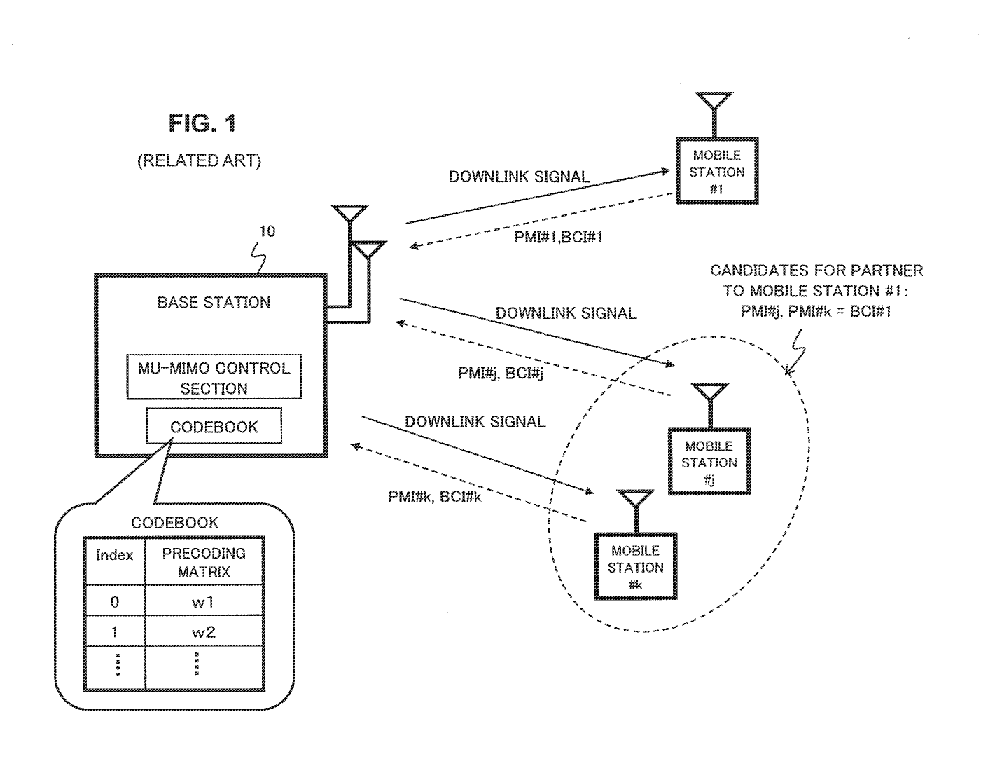

Hereinafter, illustrative embodiments will be described by taking radio communications between a base station and mobile stations in 3GPP LTE as an example. However, what communicates with a base station is not limited to a mobile station. It is sufficient to be a radio communication device or a user equipment (UE) whose reception quality can vary with the precoding matrix and, for example, may be a fixed station that is immobile. Hereinafter, a description will be given by using mobile stations in a MU-MIMO system, as an example of the radio communication devices that communicate with a base station as shown in FIG. 1.

### 1. First Illustrative Embodiment

1.1) System

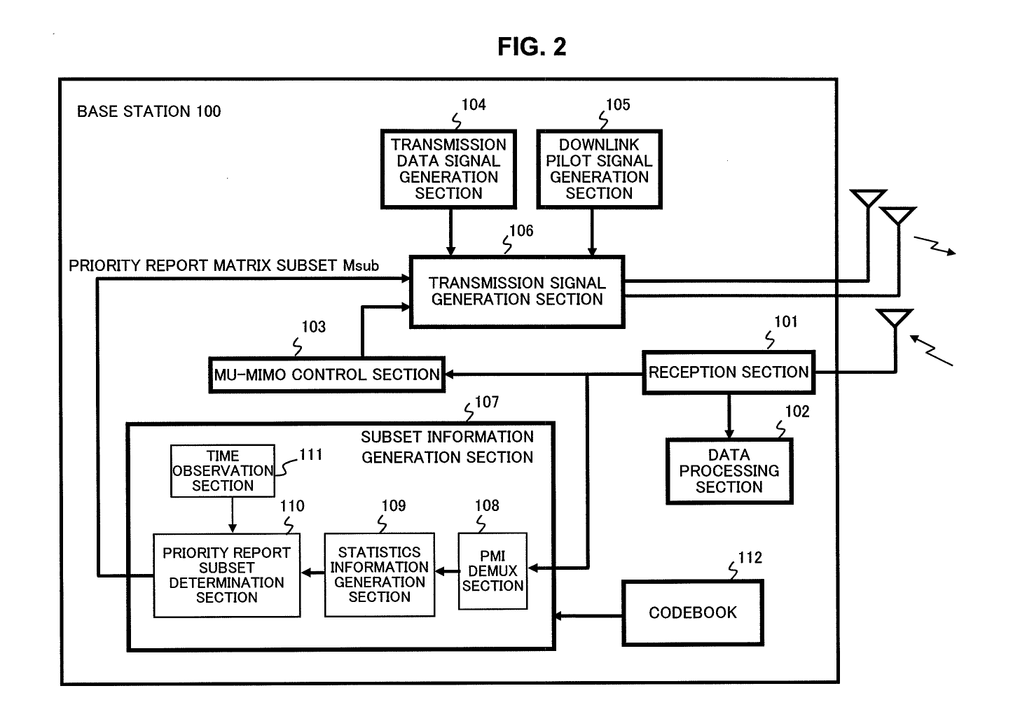

FIG. 2 shows a functional configuration of a base station 100 according to a first illustrative embodiment. The base station 100 includes a subset information generation section 107 in addition to an ordinary base station's functionality.

First, a reception section 101 of the base station 100 receives an uplink signal from a mobile station and outputs an uplink data signal to a data processing section 102 while outputting an uplink control signal to each of a MU-MIMO control section 103 and the subset information generation section 107. The data processing section 102 performs processing of reproducing uplink data, while the MU-MIMO control section 103 extracts PMI and BCI from the uplink control signal, selects mobile stations to communicate with at the same time by using the same frequency as described earlier, and outputs information about the selected mobile stations, as grouping information, to a transmission signal generation section 106. Here, the MU-MIMO control section selects a combination of those mobile stations among which PMI and BCI of a mobile station agree with BCI and PMI of another mobile station, respectively. A transmission data signal generation section 104 generates a downlink data signal to transmit to the mobile stations and outputs it to the transmission signal generation section 106. A downlink pilot signal generation section 105 generates a downlink pilot signal and outputs it to the transmission signal generation section 106. The transmission signal generation section 106 transmits the downlink transmission data signal and downlink pilot signal at the same time to the plurality of mobile stations indicated by the grouping information input from the MU-MIMO control section 103.

The subset information generation section 107 includes a PMI demultiplexing section 108, a statistics information generation section 109, a priority report subset determination section 110, and a time observation section 111, receives as an input a control signal from the reception section 101, and outputs a priority report matrix subset to the transmission signal generation section 106.

The PMI demultiplexing section 108 extracts PMIs of a plurality of mobile stations from the uplink control signal input from the reception section 101. The statistics information generation section 109 performs statistical processing (here, count of reports) for each of codebook index numbers indicated by the PMIs and generates a report probability. The time observation section 111 outputs information about the timing of transmitting a priority report matrix subset, as a subset information transmission timer signal.

The priority report subset determination section 110, at the timing of inputting the subset information transmission timer signal, compares the report probability of each codebook index number input from the statistics information generation section 109 with a predetermined probability threshold value Pth (Pth is a real number smaller than one). And, the priority report subset determination section 110 sets all PMI codebook index numbers (precoding matrix numbers) whose report probability exceeds the probability threshold value Pth into a priority report matrix subset Msub, which is then output to the transmission signal generation section 106. However, it is assumed that all codebook index numbers in a codebook 112 are set into a priority report matrix subset Msub at the time of initial setting, or if a predetermined condition is met, which will be described later.

The base station transmission signal generation section 106 receives the downlink transmission data signal, downlink pilot signal, grouping information, and priority report matrix subset Msub as inputs and transmits the downlink transmission data signal, downlink pilot signal, and priority report matrix subset Msub to the mobile stations indicated by the grouping information.

Note that a program-controlled processor (not shown) such as CPU (Central Processing Unit) is provided to the base station 100, and the function equivalent to the subset information generation section 107 can also be implemented by executing a program stored in a memory (not shown) on this program-controlled processor.

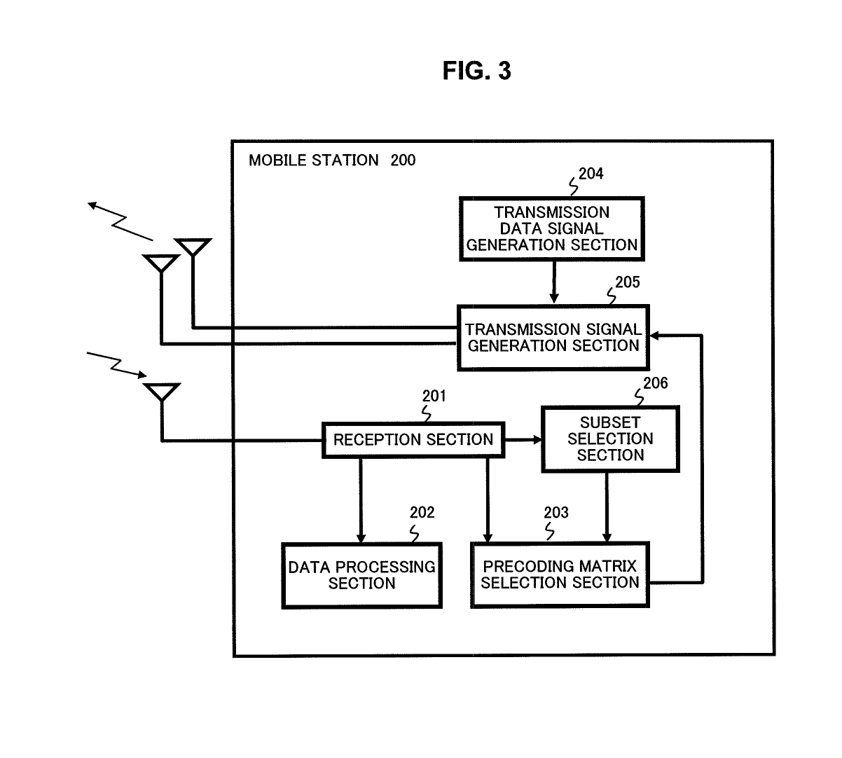

FIG. 3 shows a functional configuration of a mobile station 200 that communicates with the base station 100. The mobile station 200 includes a subset selection section 206 in addition to an ordinary mobile station's functionality.

First, a mobile station reception section 201 of the mobile station 200 demultiplexes a data signal, a downlink pilot signal, and a priority report matrix subset information from a downlink signal received from the base station 100 and outputs the data signal to a data processing section 202 that performs demodulation processing while outputting the pilot signal to a precoding matrix selection section 203 and outputting the priority report matrix subset information to the subset selection section 206.

The precoding matrix selection section 203 receives, from the subset selection section 206, a matrix subset as a range of choices for a precoding matrix number and, from the matrix subset, by using the downlink pilot signal, selects a precoding matrix number with which reception quality will be the highest to generate PMI, selects a precoding matrix number with which reception quality will be the lowest to generate BCI, and outputs the thus generated PMI and BCI as a transmission control signal to a transmission signal generation section 205. Note that it is also possible that a predetermined number of precoding matrix numbers are selected in descending order of reception quality to generate PMI and that a predetermined number of precoding matrix numbers are selected in ascending order of reception quality to generate BCI.

The subset selection section 206, based on the priority report matrix subset information, outputs the precoding matrices (codebook index numbers) included in the priority report matrix subset, as the matrix subset, to the precoding matrix selection section 203.

A transmission data signal generation section 204 generates a data signal to transmit to the base station, and the transmission signal generation section 205 transmits an uplink transmission data signal and a transmission control signal containing the selected PMI and BCI to the base station.

Note that a program-controlled processor (not shown) such as CPU (Central Processing Unit) is provided to the mobile station 200, and the function equivalent to the subset selection section 206 can also be implemented by executing a program stored in a memory (not shown) on this program-controlled processor.

1.2) Operation

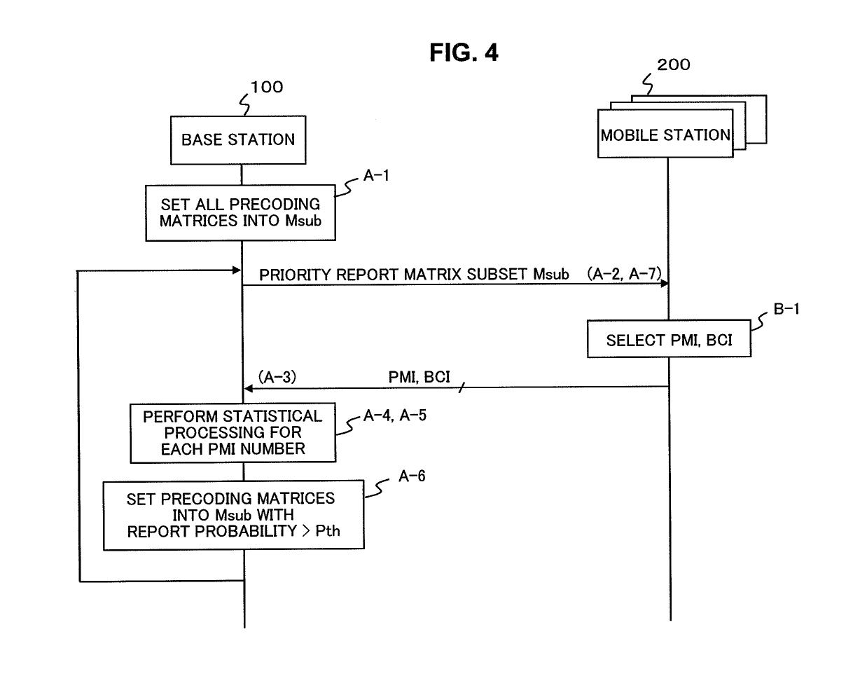

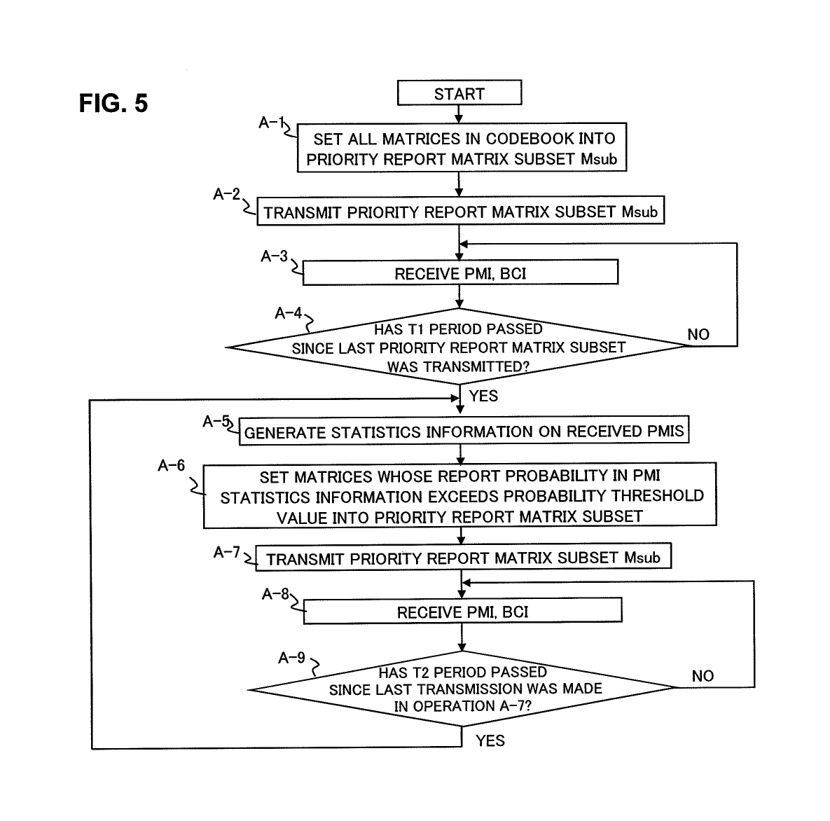

Next, feedback information control operation at the base station in the above-described system will be described with reference to FIGS. 4 and 5. The same reference signs are used in FIGS. 4 and 5 for identical operations, but the operation of the mobile station 200 will be described only with reference to the sequence diagram of FIG. 4.

Referring to FIG. 5, first, the subset information generation section 107 of the base station 100 sets all precoding matrices in the codebook 102 into a priority report matrix subset Msub (Operation A-1). Subsequently, the transmission signal generation section 106 transmits the priority report matrix subset Msub to all mobile stations 200 located within the cell of the base station 100 (Operation A-2). Upon transmission of the priority report matrix subset Msub, the time observation section 111 of the base station 100 starts a timer for time T1.

The subset selection section 206 of each mobile station 200 outputs all precoding matrix numbers included in the received priority report matrix subset Msub as a matrix subset to the precoding matrix selection section 203, and the precoding matrix selection section 203 selects PMI and BCI from among the precoding matrix numbers included in the matrix subset (Operation B-1 in FIG. 4). In this case, since all matrices in the codebook 112 are included in the priority report matrix subset set in Operation A-1, the mobile station 200 selects PMI and BCI from among all matrices in the codebook and sends them as feedback information back to the base station 100.

Upon receipt of PMI and BCI from a mobile station 200 (Operation A-3), the time observation section 111 determines whether or not the time T1 has passed since the last priority report matrix subset was transmitted (Operation A-2, Operation A-4). If the time T1 has not passed yet (Operation A-4: NO), PMI and BCI are further received from mobile stations until timeout occurs (Operation A-3). When timeout of the timer occurs (Operation A-4: YES), the statistics information generation section 109 calculates a report probability for each PMI number (Operation A-5). The priority report subset determination section 110 sets those PMI precoding matrix numbers whose report probability exceeds the probability threshold value Pth into a priority report matrix subset Msub (Operation A-6), and the transmission signal generation section 106 transmits the priority report matrix subset Msub to the mobile stations 200 (Operation A-7). Upon transmission of the priority report matrix subset Msub, the time observation section 111 of the base station 100 starts a timer for time T2.

The subset selection section 206 of each mobile station 200 outputs all precoding matrix numbers included in the received priority report matrix subset Msub as a matrix subset to the precoding matrix selection section 203, and the precoding matrix selection section 203 selects PMI and BCI from among the precoding matrix numbers included in the matrix subset (Operation B-1 in FIG. 4). In this case, since the PMI precoding matrix numbers whose report probability exceeds the probability threshold value Pth are included in the priority report matrix subset set in Operation A-6, the subset selection section 206 selects PMI and BCI from among the PMI precoding matrix numbers with high report probability and sends them as feedback information back to the base station 100.

Upon receipt of PMI and BCI from a mobile station 200 (Operation A-8), the MU-MIMO control section 103 performs grouping of those mobile stations among which PMI and BCI agree with each other as described already, and the time observation section 111 determines whether or not the time T2 has passed since the last priority report matrix subset was transmitted (Operation A-7, Operation A-9). If the time T2 has not passed yet (Operation A-9: NO), PMI and BCI are further received from mobile stations until timeout occurs (Operation A-8). When timeout of the timer occurs (Operation A-9: YES), the process returns to Operation A-5, where the statistics information generation section 109 calculates a report provability for each PMI number received. Thereafter, Operations A-5 to A-9 are repeated.

Every T2 period, Operations A-5 to A-9 are repeated, whereby the priority report matrix subset is updated. Thus, it is possible to obtain feedback information keeping up with a change in situation caused by the movement of mobile stations within the cell or into/out of the cell. For example, those mobile stations that have been handed over from other base stations and those mobile stations that have been switched on and have made initial access select PMI and BCI from the entire codebook and notify them to the base station until a next priority report matrix subset is received. Therefore, in the case where there are a large number of mobile stations handed over from other base stations, the base station receives PMIs and BCIs from mobile stations such that the percentage of PMIs and BCIs selected from the entire codebook is larger than the percentage of those selected from a priority report matrix subset. Accordingly, when the priority report matrix subset is updated, PMIs with high probability of being reported from the mobile stations handed over from other base stations are selected to be set into a priority report matrix subset.

1.3) Effects

According to the first illustrative embodiment, mobile stations report PMI and BCI selected from among matrices with high probability of being reported as PMI, and the probability that PMI of a certain mobile station agrees with BCI of another base station increases compared with the case where PMI and BCI are reported from among all matrices in the codebook. Thus, the percentage of those mobile stations that perform MU-MIMO can be increased.

Moreover, since the priority report matrix subset is updated every T2 period, if there are many mobile stations that have been newly handed over and that have made initial connection, it is possible to set PMIs with high probability of being reported from these mobile stations into a priority report matrix subset.

### 2. Second Illustrative Embodiment

In Operations A-4 and A-9 in FIG. 5 according to the above-described first illustrative embodiment, the operation is controlled through observation of passing time by using a timer. However, the present invention is not limited to this. The operation can also be controlled based on the total number of PMI and BCI samples received, as will be described next as a second illustrative embodiment.

2.1) System

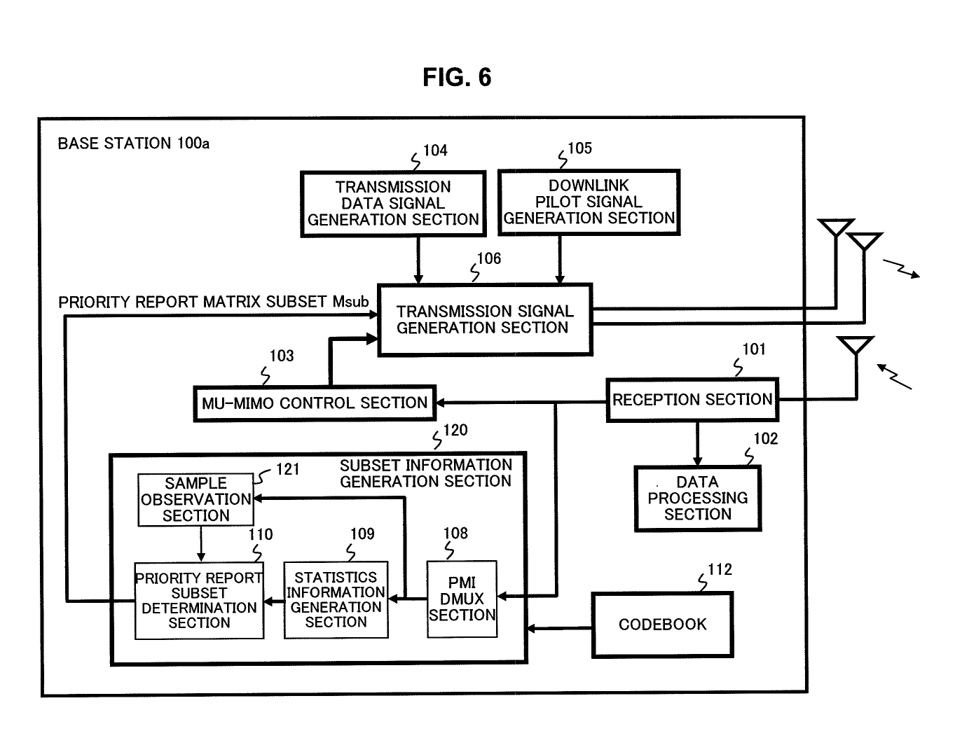

FIG. 6 shows a functional configuration of a base station 100a according to the second illustrative embodiment. The base station 100a includes a subset information generation section 120 in addition to an ordinary base station's functionality. Note that in the base station 100a according to the present illustrative embodiment, the blocks having functions similar to those of the above-described first illustrative embodiment (FIG. 2) are denoted by the same reference numerals as in the first illustrative embodiment, and a detailed description thereof will be omitted. Additionally, a description of a mobile station 200 will also be omitted because it has the same configuration as that of the first illustrative embodiment (FIG. 3).

The PMI demultiplexing section 108 of the subset information generation section 120 extracts PMI from an uplink control signal input from the reception section 101, and the statistics information generation section 109 generates a report probability for each PMI precoding matrix number and outputs them to the priority report subset determination section 110. A sample observation section 121 observes the number of demultiplexed PMI samples and, when the number of received samples reaches a threshold value, makes notification to that effect to the priority report matrix subset determination section 110.

The priority report subset determination section 110, upon receipt of the notification that the number of received samples has reached a threshold value, compares the report probability of each precoding matrix number input from the statistics information generation section 109 with a predetermined probability threshold value Pth (Pth is a real number smaller than one) and sets all PMI precoding matrix numbers whose report probability exceeds the probability threshold value Pth into a priority report matrix subset Msub, which is then output to the transmission signal generation section 106. However, it is assumed that all codebook index numbers in the codebook 112 are set into a priority report matrix subset Msub at the time of initial setting, or if a predetermined condition is met, which will be described later.

2.2) Operation

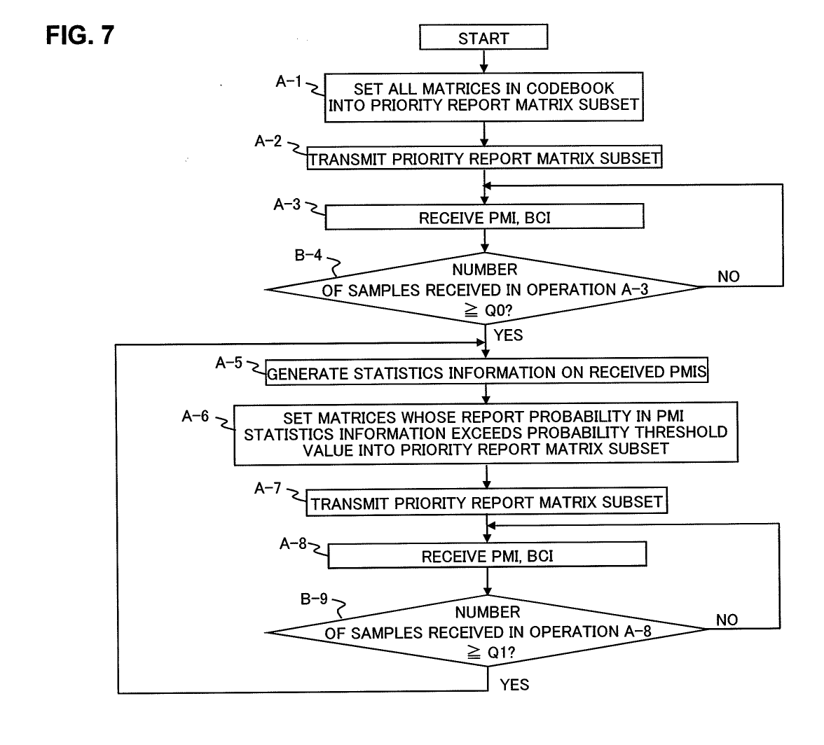

Feedback information control operation at the base station according to the present illustrative embodiment will be described with reference to FIG. 7. However, the same processing Operations as in the flowchart of FIG. 5 will be denoted by the same reference signs as in FIG. 5, and a description thereof will be omitted.

Referring FIG. 7, in Operation B-4 subsequent to Operations A-1 to A-3, the sample count observation section 121 counts samples received after the reception of PMI and BCI is started in Operation A-3 and determines whether or not the number of received samples has reached Q0 (Q0 is a natural number). If the number of received samples has not reached Q0 yet (Operation B-4: NO), the process returns to Operation A-3, where the reception of PMI and BCI from mobile stations is continued. When the number of received samples has reached Q0 (Operation B-4: YES), the statistics information generation section 109 calculates a report probability for each PMI number (Operation A-5), and Operations A-5 to A-8 are performed as described already.

In Operation B-9 subsequent to Operation A-8, the sample count observation section 121 counts samples received after the reception of PMI and BCI is started in Operation A-8 and determines whether or not the number of received samples has reached Q1 (Q1 is a natural number). If the number of received samples has not reached Q1 yet (Operation B-9: NO), the process returns to Operation A-8, where the reception of PMI and BCI from mobile stations is continued. When the number of received samples has reached Q1 (Operation B-9: YES), the process returns to Operation A-5, where the statistics information generation section 109 calculates a report probability for each PMI number received, and thereafter Operations A-5 to A-8 and B-9 are repeated. Note that a counter for the number of received samples is reset to zero after a priority report matrix subset is transmitted in Operation A-7.

Each time the number of received samples reaches Q1, Operations A-5 to A-8 and B-9 are repeated, whereby the priority report matrix subset is updated.

2.3) Modified Example

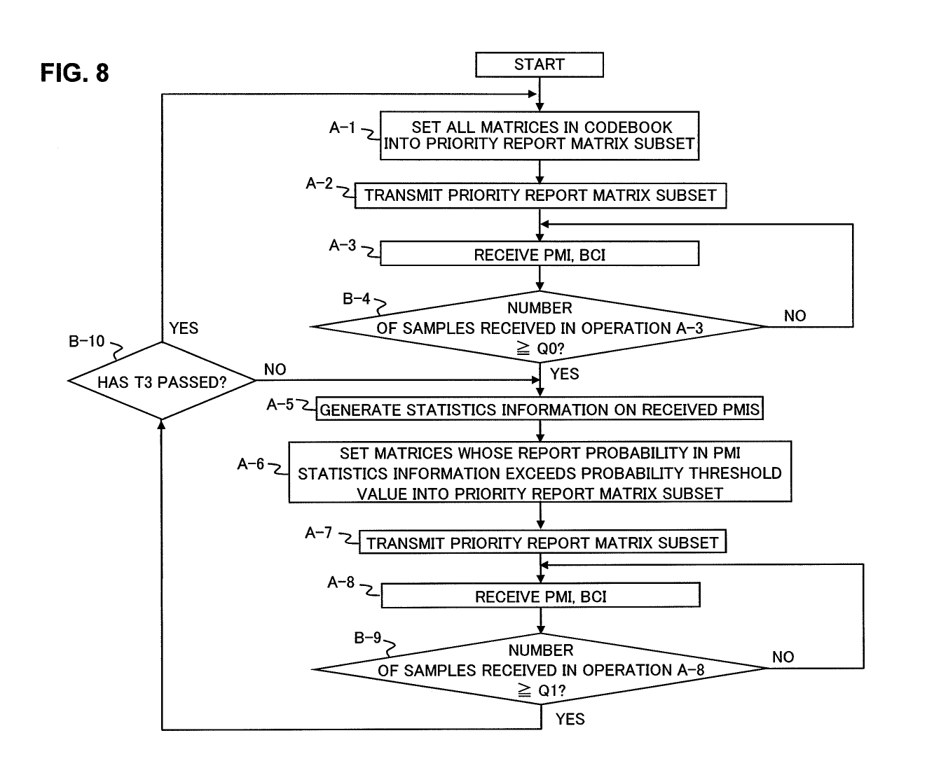

Referring to FIG. 8, since Operations A-1 to A-3 and B-4 and Operations A-5 to A-8 and B-9 are as shown in FIG. 7 and the processing contents thereof are also the same as in FIG. 7, a description thereof will be omitted. A modification example of the second illustrative embodiment shown in FIG. 8 is different from the second illustrative embodiment in that the process returns to Operation A-1 when predetermined time T3 has passed in Operation B-10. If the predetermined time T3 has not passed yet (Operation B-10: NO), the process returns to Operation A-5 as in the second illustrative embodiment.

That is, each time a T3 period has passed, all matrices in the codebook are set into a priority report matrix subset, whereby mobile stations select PMI from among all matrices and report it. Therefore, even if PMIs reported by mobile stations change with the movement of the mobile stations, a priority report matrix subset can be set so as to include PMIs with high probability of being reported by the mobile stations, and notified to the mobile stations.

2.4) Effects

According to the second illustrative embodiment, it is possible to obtain effects similar to those of the first illustrative embodiment. That is, mobile stations report PMIs and BCIs from among matrices with high probability of being reported as PMI, and the probability that PMI of a certain mobile station agrees with BCI of another base station increases compared with the case where PMI and BCI are reported from among all matrices in the codebook. Thus, the percentage of those mobile stations that perform MU-MIMO can be increased.

Moreover, according to the second illustrative embodiment, the operation is controlled based on the number of received samples, whereby statistical processing can be performed using a constant number of samples to generate a priority report matrix subset. Accordingly, it is possible to stabilize the probability that PMI agrees with BCI among mobile stations.

Furthermore, according to the modified example of the second illustrative embodiment, all matrices in the codebook are set into a priority report matrix subset every T3 period. Therefore, even if PMIs reported by mobile stations change with the movement of mobile stations, a priority report matrix subset can be set so as to include PMIs with high probability of being reported by mobile stations, and notified to the mobile stations.

### 3. Third Illustrative Embodiment

The base stations according to the above-described first and second illustrative embodiments calculate a report probability for each PMI precoding matrix number fed back from a mobile station and determine a priority report matrix subset Msub to transmit to mobile stations based on the report probability. However, the present invention is not limited to this, but as will be described as a third illustrative embodiment next, it is also possible that a base station determines a priority report matrix subset Msub uniquely based on an antenna interval at the base station. Hereinafter, a detailed description will be given.

3.1) System

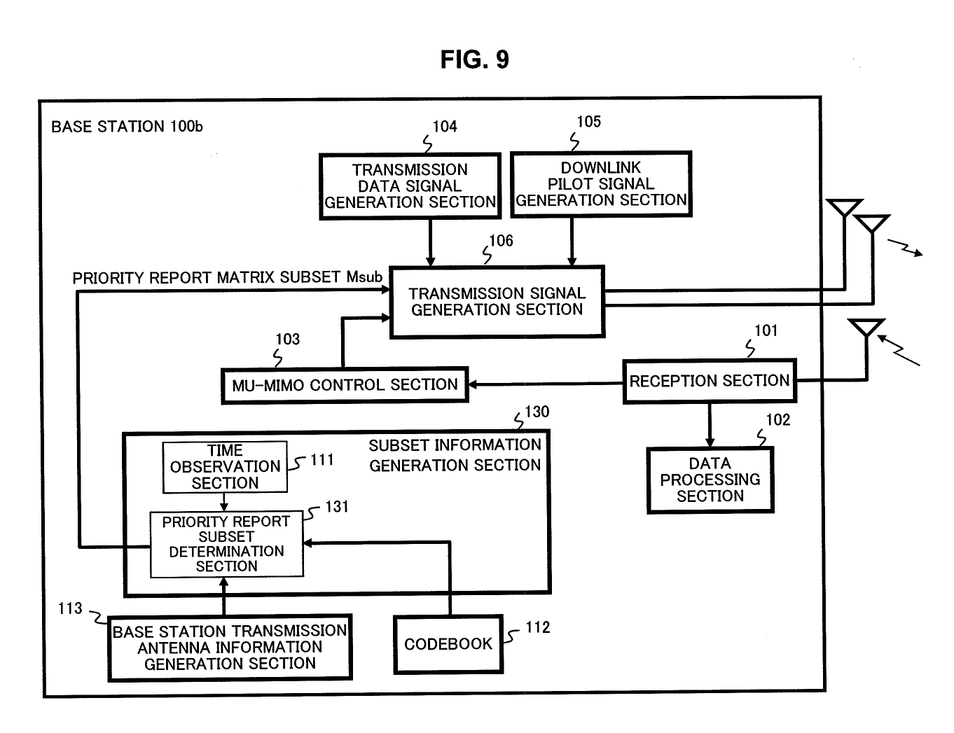

FIG. 9 shows a functional configuration of a base station 100b according to the third illustrative embodiment. The base station 100b includes a base station transmission antenna information generation section 113 and a subset information generation section 130 in addition to an ordinary base station's functionality. Note that in the base station 100b according to the present illustrative embodiment, the blocks having functions similar to those of the above-described first illustrative embodiment (FIG. 2) are denoted by the same reference numerals as in the first illustrative embodiment, and a detailed description thereof will be omitted. Additionally, a description of a mobile station 200 will also be omitted because it has the same configuration as that of the first illustrative embodiment (FIG. 3).

Referring to FIG. 9, the base station transmission antenna information generation section 113 generates information about an interval between transmission antennas of the base station and outputs it to a priority report subset determination section 131 of the subset information generation section 130. The priority report subset determination section 131, in accordance with the transmission antenna interval information, selects a priority report matrix subset Msub including those precoding matrix numbers that are predetermined for each transmission antenna interval, and outputs it to the transmission signal generation section 106.

3.2) Operation

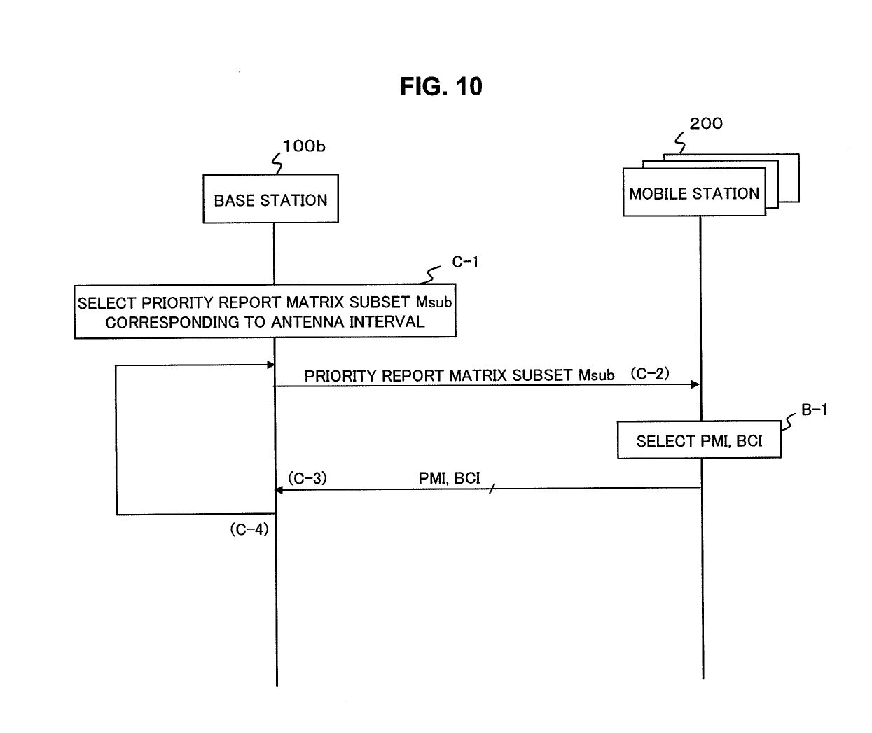

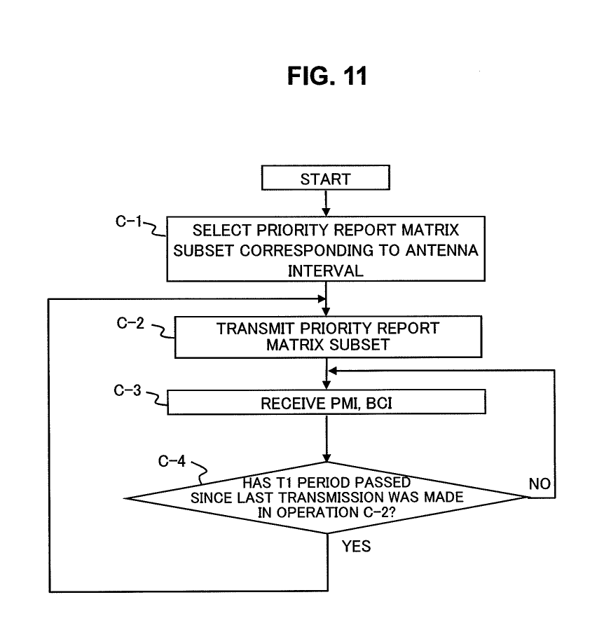

Next, feedback information control operation at the base station 100b in the above-described system will be described with reference to FIGS. 10 and 11. The same reference signs are used in FIGS. 10 and 11 for identical operations. As to the mobile station 200, since operation thereof is the same as in the first illustrative embodiment, the same reference signs as in the first illustrative embodiment are used in FIG. 10, and a description thereof will be omitted.

Referring to FIG. 11, the priority report subset determination section 131 sets a priority report matrix subset Msub including predetermined precoding matrix numbers in accordance with transmission antenna interval information input from the base station transmission antenna information generation section 113 (Operation C-1). For example, when the base station antenna interval is λ/2 (λ is a wavelength), a priority report matrix subset Msub is set using a total of seven matrices corresponding to PMIs 0, 1, 3, 4, 5, 6, and 7. When the base station antenna interval is 4λ, a total of eight matrices corresponding to PMIs 0, 1, 2, 3, 4, 5, 6, and 7 are set as a priority report matrix subset Msub.

Subsequently, the priority report subset determination section 131 transmits the priority report matrix subset Msub to mobile stations 200 through the transmission signal generation section 106 (Operation C-2). Each mobile station 200, as described already, selects PMI and BCI from the received priority report matrix subset Msub and feeds it back to the base station 100b (Operation B-1 in FIG. 10).

Upon receipt of PMI and BCI from a mobile station 200 (Operation C-3), the MU-MIMO control section 103 performs grouping of those mobile stations among which PMI and BCI agree with each other as described already, and the time observation section 111 determines whether or not a T1 period has passed since the last priority report matrix subset was transmitted (Operation C-4). When a T1 period has passed (Operation C-4: YES), the process returns to Operation C-2, where the priority report matrix subset is transmitted. If a T1 period has not passed yet, the process returns to Operation C-3, where the reception of PMI and BCI is continued.

Note that in Operation C-4 according to the present illustrative embodiment, although the operation is controlled based on passing time, it is also possible to use the total number of PMI and BCI samples received. For example, control can also be performed as follows: specifically, in Operation C-4, the process returns to Operation C-2 when the number of samples received after the reception of PMI and BCI is started in Operation C-3 has reached Q1, but when the number of samples is smaller than Q1, the process returns to Operation C-3, where the reception of PMI and BCI from mobile stations is continued.

Moreover, assuming that Sms is any one, or the sum of two or more, of the following numbers: the number of mobile stations that have been handed over from other base stations; the number of mobile stations that have been handed over to other base stations; and the number of mobile stations that have been switched on and have made initial access to the base station, it is also possible that, in Operation C-4, Sms is compared with a threshold value K, and when Sms exceeds the threshold value K, the process returns to Operation C-2, where the priority report matrix subset is transmitted.

Furthermore, in Operation C-1 according to the present illustrative embodiment, although a priority report matrix subset corresponding only to an antenna interval is selected, it is also possible to select a priority report matrix subset in accordance with an antenna interval, antenna deflection, and the like corresponding to an antenna configuration.

3.3) Effects

According to the third illustrative embodiment, it is possible to obtain effects similar to those of the first illustrative embodiment. That is, mobile stations report PMIs and BCIs selected from among matrices with high probability of being reported as PMI, whereby the probability that PMI of a certain mobile station agrees with BCI of another base station increases compared with the case where PMI and BCI are reported from among all matrices in the codebook. Thus, the percentage of those mobile stations that perform MU-MIMO can be increased.

Moreover, a result of evaluating a simulation of the system according to the third illustrative embodiment will be mentioned. Here, a configuration was made as follows: specifically, one base station covered three cells; ten mobile stations 200 were placed at random in each cell; a full queue model was used as a traffic model. Moreover, the base station 100b had four transmission antennas; the mobile stations 200 had two reception antennas; a codebook according to 3GPP LTE Re18 described in NPL 1 was used as the codebook 112, in which case the number of matrices in the codebook is 16 when the number of transmission antennas is four. The antenna interval at the base station 100b was λ/2; matrices with numbers 0, 1, 3, 4, 5, 6, and 7 were set into a priority report beam subset.

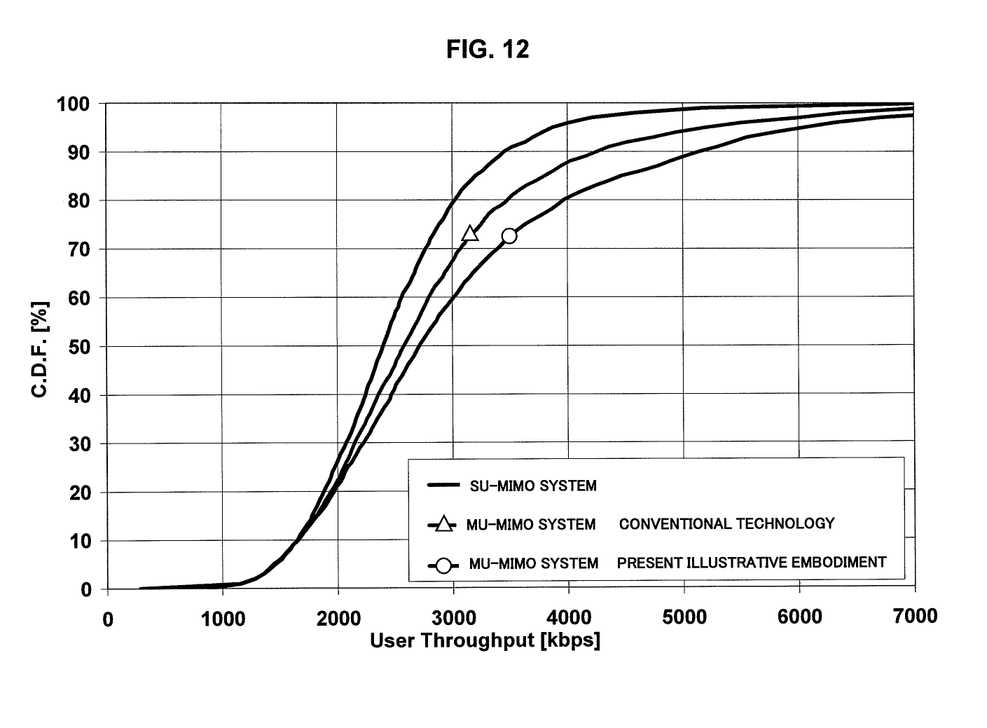

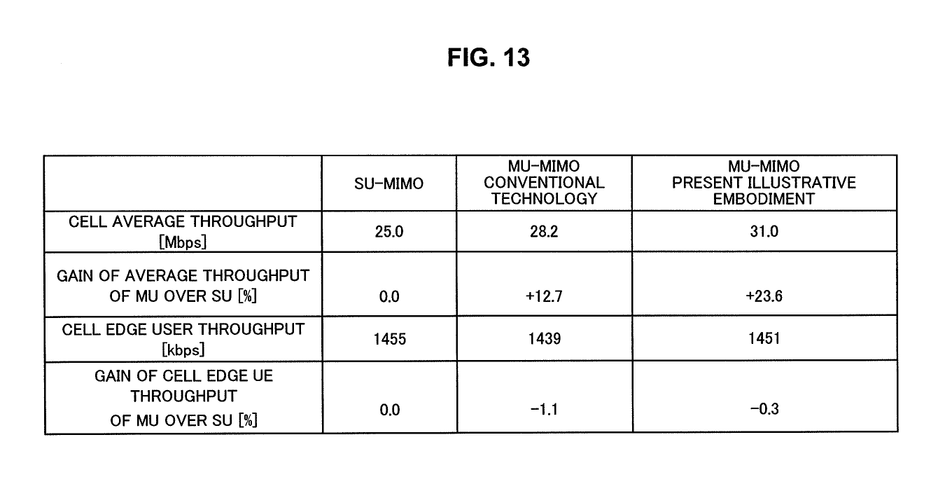

When the system according to the present illustrative embodiment was applied under the above-described conditions, the percentage of MU-MIMO reached 29%, increasing by 15% compared with a method that does not employ the present illustrative embodiment. When the present illustrative embodiment is employed, the C. D. F. (Cumulative Distribution Function) for the user throughput was improved from a conventional method as shown in FIG. 12. In addition, as shown in FIG. 13, a cell edge user throughput equivalent to that of SU-MIMO was realized while an average cell throughput was realized that was higher than those of SU-MIMO and the conventional method by 23.6% and 10.9%, respectively.

### 4. Fourth Illustrative Embodiment

In the above-described modification example of the second illustrative embodiment (FIG. 8), all matrices in the codebook are set into a priority report matrix subset each time a T3 period has passed. However, the present invention is not limited to this, but as will be described as a fourth illustrative embodiment next, it is also possible that the priority report matrix subset Msub is re-set to include all matrices, depending on the number of mobile stations that start or end connection to a base station. Hereinafter, a detailed description will be given.

4.1) System

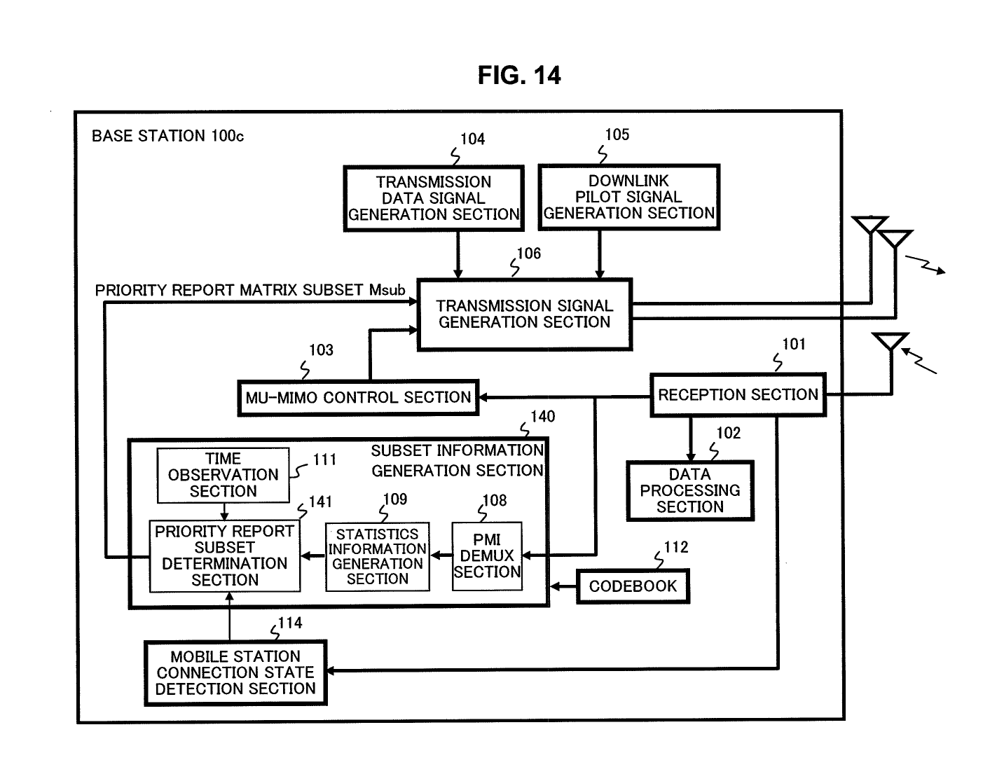

FIG. 14 shows a functional configuration of a base station 100c according to the fourth illustrative embodiment. The base station 100c includes a subset information generation section 140 and a mobile station connection state detection section 114 in addition to an ordinary base station's functionality. Note that in the base station 100c according to the present illustrative embodiment, the blocks having functions similar to those of the above-described first illustrative embodiment (FIG. 2) are denoted by the same reference numerals as in the first illustrative embodiment, and a detailed description thereof will be omitted. Additionally, a description of a mobile station 200 will also be omitted because it has the same configuration as that of the first illustrative embodiment (FIG. 3).

Referring to FIG. 14, the subset information generation section 140 includes the PMI demultiplexing section 108, the statistics information generation section 109, a priority report subset determination section 141, and the time observation section 111, receives as an input a control signal from the reception section 101, and outputs a priority report matrix subset Msub to the transmission signal generation section 106.

The mobile station connection state detection section 114 measures the number of mobile stations that have started connection to the base station 100c and the number of mobile stations that have ended connection to the base station 100c, by using reception signals from mobile stations. Here, the mobile stations that have started connection are those that have been handed over from other base stations and those that have made initial access, and the mobile stations that have ended connection are those that have been handed over to other base stations and those that have been switched off. The mobile station connection state detection section 114 outputs a subset information transmission trigger signal to the priority report subset determination section 141 when the sum of the numbers of connection start mobile stations and connection end mobile stations is equal to or larger than a threshold value K.

The priority report subset determination section 141 sets all precoding matrix numbers in the codebook 112 into a priority report matrix subset Msub at the timing of the subset information transmission trigger signal from the mobile station connection state detection section 114. Other than the timing of the subset information transmission trigger signal, as in the first illustrative embodiment, the priority report subset determination section 141 compares the report probability of each codebook index number input from the statistics information generation section 109 with a predetermined probability threshold value Pth (Pth is a real number smaller than one) and sets all PMI codebook index numbers whose report probability exceeds the probability threshold value Pth into a probability report matrix subset Msub, which is then output to the transmission signal generation section 106.

4.2) Operation

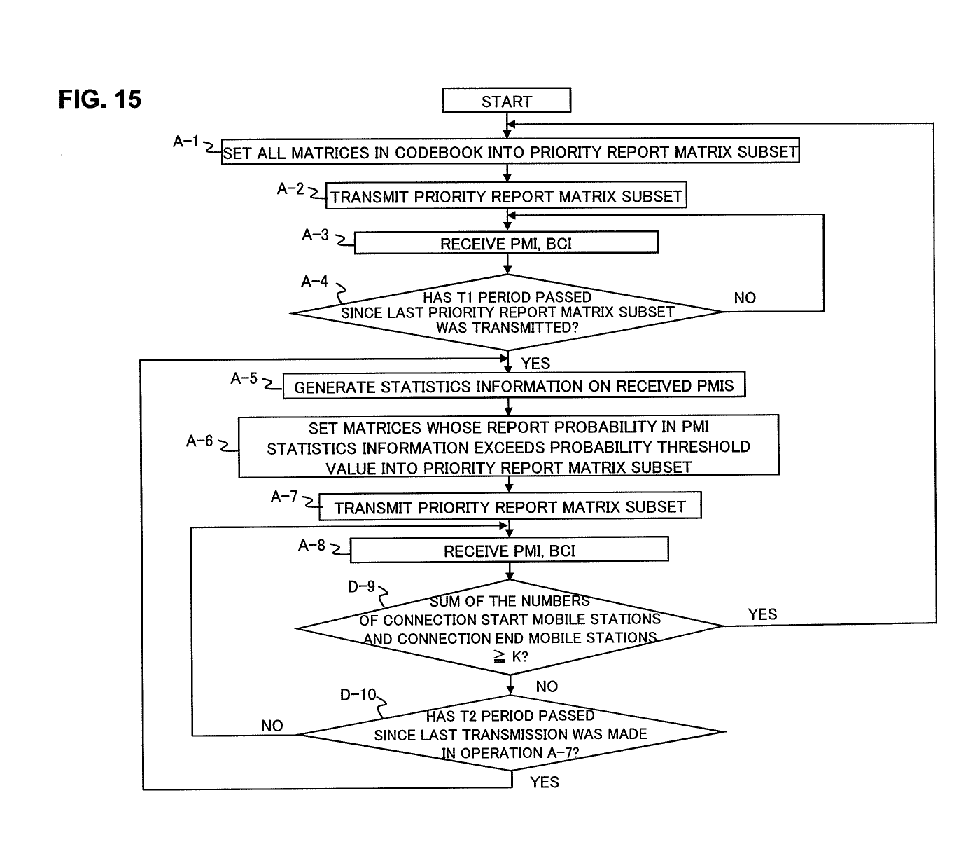

Feedback information control operation at the base station according to the present illustrative embodiment will be described with reference to FIG. 15. However, the same processing operations as in the flowchart of FIG. 5 will be denoted by the same reference signs as in FIG. 5, and a description thereof will be omitted. As to the mobile station 200, since operation thereof is the same as in the first illustrative embodiment, a description thereof will be omitted.

Referring to FIG. 15, since Operations A-1 to A-8 are the same as those shown in FIG. 5, a description will be given of operations in Operations D-9 and D-10 following Operation A-8.

In Operation D-9, assuming that Sms is the sum of the following numbers: the number of mobile stations that have been handed over from other base stations; the number of mobile stations that have been handed over to other base stations; the number of mobile stations that have been switched off; and the number of mobile stations that have been switched on and have made initial access to the base station, the mobile station connection state detection section 114 compares Sms with the threshold value K and, when the sum Sms of the numbers of mobile stations as described above is equal to or larger than the threshold value K, outputs a subset information transmission trigger signal (Operation D-9: YES). When the subset information transmission trigger signal is input, the process returns to Operation A-1, where the priority report subset determination section 141 sets all matrices in the codebook into a priority report matrix subset. When the sum Sms, which indicates the extent of variation in the connection state of mobile stations, is large, there is a high possibility that a great change occurs in the report probabilities of individual PMI precoding matrix numbers reported from mobile stations. Therefore, it is preferable, but not necessary, that the process returns to Operation A-1 to have mobile stations report PMIs and BCIs from among all matrices in the codebook. If the sum Sms of the numbers of mobile stations is not larger than the threshold value K, the process goes to Operation D-10.

In Operation D-10, if a T2 (T2 is a positive real number) period has passed since the last priority report matrix subset was transmitted in Operation A-7 (Operation D-10: YES), the process returns to Operation A-5, where the priority report matrix subset is updated. If a T2 period has not passed yet (Operation D-10: NO), the process returns to Operation A-8, where the reception of PMI and BCI from mobile stations is continued.

Note that in Operations A-4 and D-10 according to the present illustrative embodiment, although the operation is controlled through observation of passing time by using a timer, it is also possible to control the operation based on the total number of PMI and BCI samples received as described in the second illustrative embodiment. For example, in Operation A-4, the process goes to Operation A-5 when the number of samples received after the reception of PMI is started in Operation A-3 has reached Q1, but when the number of samples is smaller than Q1, the process returns to Operation A-3, where the reception of PMI and BCI from mobile stations is continued.

Moreover, in Operation D-10, the process goes to Operation A-5 when the number of samples received after the reception of PMI is started in Operation A-8 has reached Q2, but when the number of samples is smaller than Q2, the process returns to Operation A-8, where the reception of PMI and BCI from mobile stations is continued.

It is also possible that in Operation D-9, the mobile station connection state detection section 114 compares Sms with the threshold value K and then outputs a subset information transmission trigger signal, where Sms is any one, or the sum of two or more, of the following numbers: the number of mobile stations that have been handed over from other base stations; the number of mobile stations that have been handed over to other base stations; the number of mobile stations that have been switched off; and the number of mobile stations that have been switched on and have made initial access to the base station.

4.3) Effects

According to the fourth illustrative embodiment, it is possible to obtain effects similar to those of the first illustrative embodiment. That is, mobile stations report PMIs and BCIs from among matrices with high probability of being reported as PMI, and the probability that PMI of a certain mobile station agrees with BCI of another base station increases compared with the case where PMI and BCI are reported from among all matrices in the codebook. Thus, the percentage of those mobile stations that perform MU-MIMO can be increased.

Moreover, as mentioned earlier, those mobile stations that have been handed over from other base stations and those mobile stations that have been switched on and have made initial access to the base station do not have information about a priority report matrix subset. Therefore, according to the present illustrative embodiment, when the sum of the number of mobile stations that have been handed over from other base stations, the number of mobile stations that have been handed over to other base stations, the number of mobile stations that have been switched off, and the number of mobile stations that have been switched on and have made initial access to the base station is equal to or larger than the threshold value K, a priority report matrix subset in which all matrices in the codebook are set is transmitted to mobile stations, whereby precoding matrix numbers with high probability of being reported by mobile stations can be set into a priority report matrix subset. Thus, the percentage of those mobile stations that perform MU-MIMO can be further increased.

### 5. Fifth Illustrative Embodiment

In Operations A-4 and D-10 in FIG. 15 according to the above-described fourth illustrative embodiment, the operation is controlled through observation of passing time by using a timer. However, the present invention is not limited to this. The operation can also be controlled based on the total number of PMI and BCI samples received, as will be described next as a fifth illustrative embodiment.

5.1) System

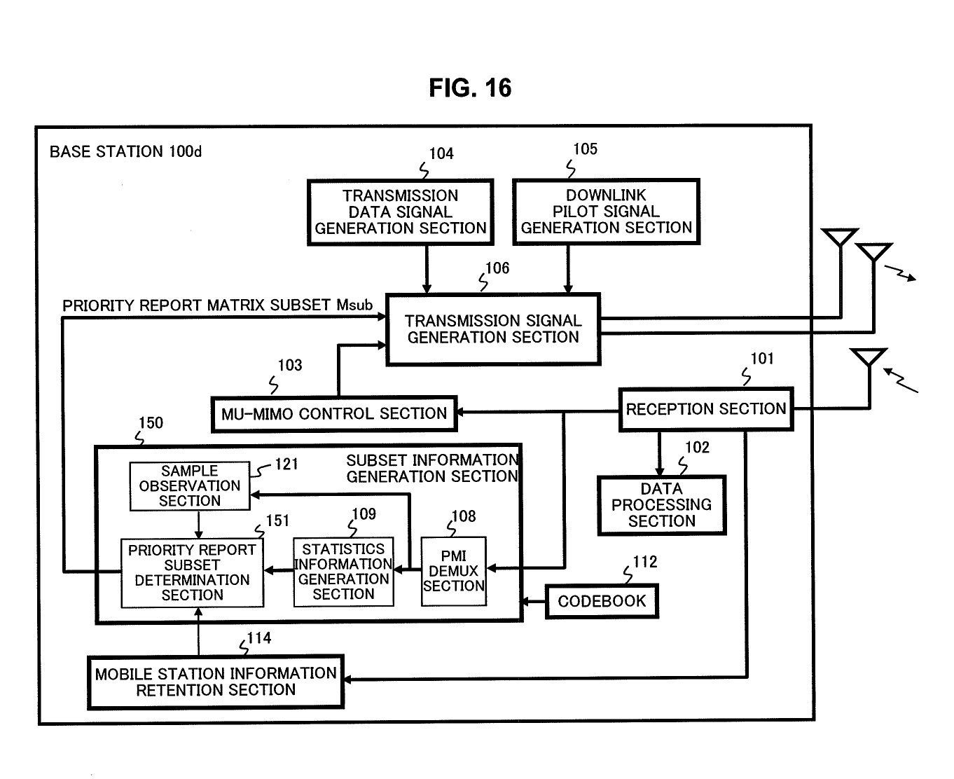

FIG. 16 shows a functional configuration of a base station 100d according to the fifth illustrative embodiment. The base station 100d includes a subset information generation section 150 and a mobile station connection state detection section 114 in addition to an ordinary base station's functionality. Note that in the base station 100d according to the present illustrative embodiment, the blocks having functions similar to those of the above-described second illustrative embodiment (FIG. 6) and the fourth illustrative embodiment (FIG. 14) are denoted by the same reference numerals as in the second or fourth illustrative embodiment, and a detailed description thereof will be omitted. Additionally, a description of a mobile station 200 will also be omitted because it has the same configuration as that of the first illustrative embodiment (FIG. 3).

Referring to FIG. 16, the subset information generation section 150 includes the PMI demultiplexing section 108, the statistics information generation section 109, a priority report subset determination section 151, and the sample observation section 121, receives as an input a control signal from the reception section 101, and outputs a priority report matrix subset Msub to the transmission signal generation section 106. The sample observation section 121 observes the number of PMI samples demultiplexed by the PMI demultiplexing section 108 and, when the number of received samples reaches a threshold value, makes a notification to that effect to the priority report matrix subset determination section 151.

The mobile station connection state detection section 114, as described in the fourth illustrative embodiment, outputs a subset information transmission trigger signal to the priority report subset determination section 151 when the sum of the numbers of mobile stations that have started connection and mobile stations that have ended connection is equal to or larger than a threshold value K.

The priority report subset determination section 151, upon receipt of the notification that the number of received samples has reached the threshold value, compares the report probability of each precoding matrix number input from the statistics information generation section 109 with a predetermined probability threshold value Pth (Pth is a real number smaller than one) and sets all PMI precoding matrix numbers whose report probability exceeds the probability threshold value Pth into a priority report matrix subset Msub, which is then output to the transmission signal generation section 106. However, all precoding matrix numbers in the codebook 112 are set into a priority report matrix subset Msub at the time of the subset information transmission trigger signal from the mobile station connection state detection section 114.

5.2) Operation

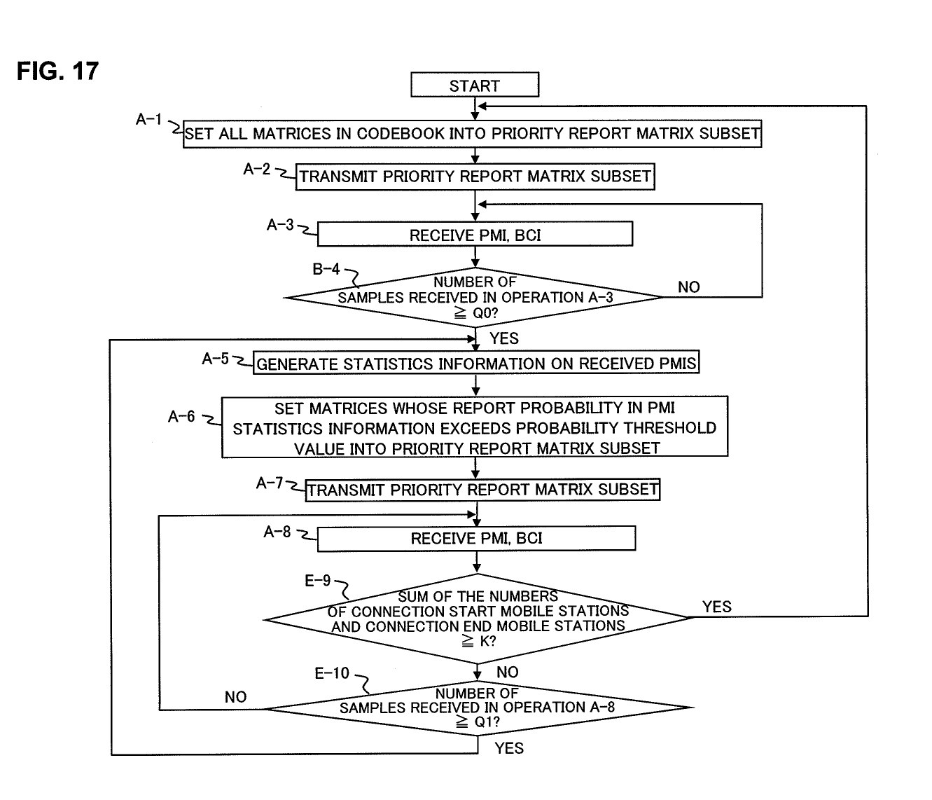

Feedback information control operation at the base station according to the present illustrative embodiment will be described with reference to FIG. 17. However, the same processing operations as in the flowchart of FIG. 7 used to describe the second illustrative embodiment will be denoted by the same reference signs as in FIG. 7, and a description thereof will be omitted. As to the mobile station 200, since operation thereof is the same as in the first illustrative embodiment, a description thereof will be omitted.

Referring to FIG. 17, since Operations A-1 to A-3 and B-4 and Operations A-5 to A-8 are the same as those shown in FIG. 7, a description will be given in Operations E-9 and E-10 following Operation A-8.

In Operation E-9, assuming that Sms is the sum of the following numbers: the number of mobile stations that have been handed over from other base stations; the number of mobile stations that have been handed over to other base stations; and the number of mobile stations that have been switched on and have made initial access to the base station, the mobile station connection state detection section 114 compares Sms with the threshold value K and, when the sum Sms of the numbers of mobile stations is equal to or larger than the threshold value K, outputs a subset information transmission trigger signal (Operation E-9: YES). When the subset information transmission trigger signal is input, the process returns to Operation A-1, where the priority report subset determination section 151 sets all matrices in the codebook into a priority report matrix subset. When the sum Sms, which indicates the extent of variation in the connection state of mobile stations, is large, there is a high possibility that a great change occurs in the report probabilities of individual PMI precoding matrix numbers reported from mobile stations. Therefore, it is preferable, but not necessary, that the process returns to Operation A-1 to have mobile stations report PMI and BCI from among all matrices in the codebook. If the sum Sms of the numbers of mobile stations as described above is not larger than the threshold value K, the process moves to Operation E-10.

In Operation E-10, the sample count observation section 121 counts samples received after the reception of PMI and BCI is started in Operation A-8 and determines whether or not the number of received samples has reached Q1 (Q1 is a natural number). If the number of received samples has not reached Q1 yet (Operation E-10: NO), the process returns to Operation A-8, where the reception of PMI and BCI from mobile stations is continued. When the number of received samples has reached Q1 (Operation E-10: YES), the process returns to Operation A-5, where the statistics information generation section 109 calculates a report probability for each PMI number received, and thereafter Operations A-5 to A-8, E-9, and E-10 are repeated. Each time the number of received samples reaches Q1, Operations A-5 to A-8 and E-9 are repeated, whereby the priority report matrix subset is updated.

5.3) Effects

According to the fifth illustrative embodiment, it is possible to obtain effects similar to those of the first illustrative embodiment. That is, mobile stations report PMI and BCI from among matrices with high probability of being reported as PMI, whereby the probability that PMI of a certain mobile station agrees with BCI of another base station increases compared with the case where PMI and BCI are reported from among all matrices in the codebook. Thus, the percentage of those mobile stations that perform MU-MIMO can be increased.

Moreover, as in the above-described fourth illustrative embodiment, when the sum of the number of mobile stations that have been handed over from other base stations, the number of mobile stations that have been handed over to other base stations, and the number of mobile stations that have been switched on and have made initial access to the base station is equal to or larger than the threshold value K, a priority report matrix subset in which all matrices in the codebook are set is transmitted to mobile stations, whereby precoding matrix numbers with high probability of being reported by mobile stations can be set into a priority report matrix subset. Thus, the percentage of those mobile stations that perform MU-MIMO can be further increased.

Furthermore, as in the second illustrative embodiment, the operation is controlled based on the number of received samples, whereby statistical processing can be performed using a constant number of samples to generate a priority report matrix subset. Accordingly, it is possible to stabilize the probability that PMI agrees with BCI among mobile stations.

### 6. Additional Statements

An illustrative embodiment is applicable to 3GPP LTE MU-MIMO systems. The present invention may be embodied in other specific forms without departing from the spirit or essential characteristics thereof. The above-described illustrative embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein. Part or all of the above-described illustrative embodiments can also be described as, but are not limited to, the following additional statements.

(Additional Statement 1)

A feedback information control method of a base station in a radio communication system in which a radio communication device feeds information on a precoding matrix back to the base station, comprising:

selecting M precoding matrices from a predetermined number (N) of precoding matrices to set the M precoding matrices into a precoding matrix subset, where N is an integer equal to or greater than 2 and M is an integer equal to or greater than 1 and equal to or smaller than N;

transmitting the precoding matrix subset to the radio communication device; and

receiving feedback information from the radio communication device, wherein the feedback information includes information on a plurality of precoding matrices which are selected from the precoding matrix subset based on reception quality at the radio communication device.

(Additional Statement 2)

The feedback information control method according to additional statement 1, wherein the plurality of precoding matrices includes at least one first precoding matrix which provides higher reception quality at the radio communication device and at least one second precoding matrix which provides lower reception quality at the radio communication device.

(Additional Statement 3)

The feedback information control method according to additional statement 2, wherein a plurality of first precoding matrices are selected in descending order of reception quality and a plurality of second precoding matrix numbers are selected in ascending order of reception quality.

(Additional Statement 4)

The feedback information control method according to additional statement 2, wherein the M precoding matrices are selected from the N precoding matrices based on feedback probabilities of precoding matrices providing higher reception quality fed back from a plurality of radio communication devices.

(Additional Statement 5)

The feedback information control method according to additional statement 4, wherein the M precoding matrices are selected from the N precoding matrices by: counting precoding matrices providing higher reception quality for each of the N precoding matrices; and selecting M precoding matrices whose feedback probabilities exceed a predetermined threshold value to generate the precoding matrix subset.

(Additional Statement 6)

The feedback information control method according to additional statement 1, further comprising: updating the precoding matrix subset by selecting M precoding matrices based on feedback information received from the radio communication device.

(Additional Statement 7)

The feedback information control method according to additional statement 6, wherein the updating is performed by:

transmitting an initial precoding matrix subset to a plurality of radio communication devices, wherein the initial precoding matrix subset is the precoding matrix subset into which the N precoding matrices are set;

receiving feedback information from each of the plurality of radio communication devices until a predetermined condition is satisfied, wherein the feedback information includes information on at least one first precoding matrix which provides higher reception quality at each radio communication device and at least one second precoding matrix which provides lower reception quality at each radio communication device; and

selecting the M precoding matrices from the N precoding matrices based on feedback probabilities of precoding matrices providing higher reception quality received until the predetermined condition has been satisfied.

(Additional Statement 8)

The feedback information control method according to additional statement 7, wherein the precoding matrix subset is reset to the initial precoding matrix subset every time a predetermined time period has elapsed.

(Additional Statement 9)

The feedback information control method according to additional statement 7, wherein the precoding matrix subset is reset to the initial precoding matrix subset every time the sum of the number of radio communication devices which start connection to the base station within a radio coverage of the base station and the number of radio communication devices which end the connection becomes equal to or greater than a predetermined threshold value.

(Additional Statement 10)

The feedback information control method according to additional statement 1, wherein the M precoding matrices are selected from the N precoding matrices depending on antenna configuration of the base station.

(Additional Statement 11)

The feedback information control method according to additional statement 1, wherein the feedback information received from the radio communication device includes PMI (Precoding Matrix Indicator) which is information on precoding matrix providing higher reception quality and BCI (Best Companion Indicator) which is information on precoding matrix providing lower reception quality.

(Additional Statement 12)

A base station which receives feedback information on a precoding matrix from a radio communication device in a radio communication system, comprising:

a subset information generation section for selecting M precoding matrices from a predetermined number (N) of precoding matrices to set the M precoding matrices into a precoding matrix subset, where N is an integer equal to or greater than 2 and M is an integer equal to or greater than 1 and equal to or smaller than N;

a transmission section for transmitting the precoding matrix subset to the radio communication device; and

a reception section for receiving feedback information from the radio communication device, wherein the feedback information includes information on a plurality of precoding matrices which are selected from the precoding matrix subset based on reception quality at the radio communication device.

(Additional Statement 13)

The base station according to additional statement 12, wherein the plurality of precoding matrices includes at least one first precoding matrix which provides higher reception quality at the radio communication device and at least one second precoding matrix which provides lower reception quality at the radio communication device.

(Additional Statement 14)

The base station according to additional statement 13, wherein the subset information generation section selects a plurality of first precoding matrices in descending order of reception quality and selects a plurality of second precoding matrix numbers in ascending order of reception quality.

(Additional Statement 15)

The base station according to additional statement 13, wherein the subset information generation section selects the M precoding matrices from the N precoding matrices based on feedback probabilities of precoding matrices providing higher reception quality fed back from a plurality of radio communication devices.

{0099}

(Additional Statement 16)

The base station according to additional statement 15, wherein the subset information generation section comprises:

a statistic processing section for counting precoding matrices providing higher reception quality for each of the N precoding matrices; and

a subset determination section for generating the precoding matrix subset by selecting M precoding matrices whose feedback probabilities exceed a predetermined threshold value.

(Additional Statement 17)

The base station according to additional statement 12, wherein the subset information generation section updates the precoding matrix subset by selecting M precoding matrices based on feedback information received from the radio communication device.

(Additional Statement 18)

The base station according to additional statement 17, wherein the subset information generation section updates the precoding matrix subset by:

transmitting an initial precoding matrix subset to a plurality of radio communication devices, wherein the initial precoding matrix subset is the precoding matrix subset into which the N precoding matrices are set;

receiving feedback information from each of the plurality of radio communication devices until a predetermined condition is satisfied, wherein the feedback information includes information on at least one first precoding matrix which provides higher reception quality at each radio communication device and at least one second precoding matrix which provides lower reception quality at each radio communication device; and

selecting the M precoding matrices from the N precoding matrices based on feedback probabilities of precoding matrices providing higher reception quality received until the predetermined condition has been satisfied.

(Additional Statement 19)

The base station according to additional statement 18, wherein the subset information generation section resets the precoding matrix subset to the initial precoding matrix subset every time a predetermined time period has elapsed.

(Additional Statement 20)

The base station according to additional statement 18, further comprising:

a detection section for detecting that the sum of the number of radio communication devices which start connection to the base station within a radio coverage of the base station and the number of radio communication devices which end the connection becomes equal to or greater than a predetermined threshold value,

wherein the subset information generation section resets the precoding matrix subset to the initial precoding matrix subset every time the sum is equal to or greater than the predetermined threshold value.

(Additional Statement 21)

The base station according to additional statement 12, wherein the subset information generation section selects the M precoding matrices from the N precoding matrices depending on antenna configuration of the base station.

(Additional Statement 22)

The base station according to additional statement 12, wherein the feedback information received from the radio communication device includes PMI (Precoding Matrix Indicator) which is information on precoding matrix providing higher reception quality and BCI (Best Companion Indicator) which is information on precoding matrix providing lower reception quality.

(Additional Statement 23)

A radio communication system comprising a base station and a plurality of radio communication devices each communicating with the base station, wherein the base station comprises:

a subset information generation section for selecting M precoding matrices from a predetermined number (N) of precoding matrices to set the M precoding matrices into a precoding matrix subset, where N is an integer equal to or greater than 2 and M is an integer equal to or greater than 1 and equal to or smaller than N;

a transmission section for transmitting the precoding matrix subset to a radio communication device; and

a reception section for receiving feedback information from the radio communication device,

wherein each radio communication device transmits the feed back information back to the base station, wherein the feedback information includes information on a plurality of precoding matrices which are selected from the precoding matrix subset based on reception quality at the radio communication device.

(Additional Statement 24)

A radio communication device in the radio communication system according to additional statement 23, comprising:

a selection section for selecting a first precoding matrix which provides higher reception quality at the radio communication device and a second precoding matrix which provides lower reception quality at the radio communication device, from the precoding matrix subset; and

a transmission section for transmitting selected precoding matrices as feedback information to the base station.

(Additional Statement 25)

A computer-readable program functioning a computer as a base station which receives feedback information on a precoding matrix from a radio communication device in a radio communication system, comprising:

selecting M precoding matrices from a predetermined number (N) of precoding matrices to set the M precoding matrices into a precoding matrix subset, where N is an integer equal to or greater than 2 and M is an integer equal to or greater than 1 and equal to or smaller than N;

transmitting the precoding matrix subset to the radio communication device; and

receiving feedback information from the radio communication device, wherein the feedback information includes information on a plurality of precoding matrices which are selected from the precoding matrix subset based on reception quality at the radio communication device.

(Additional Statement 26)

A computer-readable program functioning a computer as a radio communication device in the radio communication system according to additional statement 23, comprising:

selecting a first precoding matrix which provides higher reception quality at the radio communication device and a second precoding matrix which provides lower reception quality at the radio communication device, from the precoding matrix subset; and

transmitting selected precoding matrices as feedback information to the base station.

1. A feedback information control method comprising:
selecting M precoding matrices from a predetermined number (N) of precoding matrices to set the M precoding matrices as a precoding matrix subset,
wherein N is an integer equal to or greater than 2 and M is an integer equal to or greater than 1 and equal to or smaller than N;
transmitting the precoding matrix subset to a radio communication device; and
receiving, at a base station, feedback information from the radio communication device,
wherein the feedback information includes information about at least one precoding matrix which is selected from the precoding matrix subset based on reception quality at the radio communication device.

2. The feedback information control method according to claim 1, wherein the feedback information includes information about plural selected precoding matrices including at least one first precoding matrix, which provides higher reception quality at the radio communication device, and at least one second precoding matrix, which provides lower reception quality at the radio communication device.

3. The feedback information control method according to claim 2, wherein a plurality of first precoding matrices are selected in descending order of reception quality, and
wherein a plurality of second precoding matrices are selected in ascending order of reception quality.

4. The feedback information control method according to claim 2, wherein the M precoding matrices are selected from the N precoding matrices based on feedback probabilities of precoding matrices providing higher reception quality fed back from a plurality of radio communication devices.

5. The feedback information control method according to claim 4, wherein the M precoding matrices are selected from the N precoding matrices by:
counting precoding matrices providing higher reception quality for each of the N precoding matrices; and
selecting M precoding matrices whose feedback probabilities exceed a predetermined threshold value.

6. The feedback information control method according to claim 1, further comprising: updating the precoding matrix subset by selecting the M precoding matrices based on feedback information received from the radio communication device.

7. The feedback information control method according to claim 6, wherein the updating is performed by:
transmitting an initial precoding matrix subset to a plurality of radio communication devices,
wherein the initial precoding matrix subset is the precoding matrix subset;
receiving feedback information from each of the plurality of radio communication devices until a predetermined condition is satisfied,
wherein the feedback information includes information about at least one first precoding matrix which provides higher reception quality at each respective radio communication device and at least one second precoding matrix which provides lower reception quality at each respective radio communication device; and
selecting the M precoding matrices from the N precoding matrices based on feedback probabilities of precoding matrices providing higher reception quality received until the predetermined condition has been satisfied.

8. The feedback information control method according to claim 7, wherein the precoding matrix subset is reset to the initial precoding matrix subset every time a predetermined time period has elapsed.

9. The feedback information control method according to claim 7, wherein the precoding matrix subset is reset to the initial precoding matrix subset every time a sum of the number of radio communication devices which start connection to the base station within a radio coverage of the base station and the number of radio communication devices which end connection becomes equal to or greater than a predetermined threshold value.

10. The feedback information control method according to claim 1, wherein the M precoding matrices are selected from the N precoding matrices depending on an antenna configuration of the base station.

11. The feedback information control method according to claim 1, wherein the feedback information received from the radio communication device includes:
a PMI (Precoding Matrix Indicator), which is information about a precoding matrix providing higher reception quality; and
a BCI (Best Companion Indicator), which is information about a precoding matrix providing lower reception quality.

12. A base station comprising:
a subset information generation section which selects M precoding matrices from a predetermined number (N) of precoding matrices to set the M precoding matrices as a precoding matrix subset,
wherein N is an integer equal to or greater than 2 and M is an integer equal to or greater than 1 and equal to or smaller than N;
a transmission section which transmits the precoding matrix subset to a radio communication device; and
a reception section which receives feedback information from the radio communication device,
wherein the feedback information includes information about at least one precoding matrix which is selected from the precoding matrix subset based on reception quality at the radio communication device.

13. The base station according to claim 12, wherein the feedback information includes information about plural selected precoding matrices including at least one first precoding matrix, which provides higher reception quality at the radio communication device, and at least one second precoding matrix, which provides lower reception quality at the radio communication device.

14. The base station according to claim 13, wherein the subset information generation section selects a plurality of first precoding matrices in descending order of reception quality, and
wherein the subset information generation section selects a plurality of second precoding matrix numbers in ascending order of reception quality.

15. The base station according to claim 13, wherein the subset information generation section selects the M precoding matrices from the N precoding matrices based on feedback probabilities of precoding matrices providing higher reception quality fed back from a plurality of radio communication devices.

16. The base station according to claim 15, wherein the subset information generation section comprises:
a statistic processing section for counting precoding matrices providing higher reception quality for each of the N precoding matrices; and
a subset determination section for generating the precoding matrix subset by selecting M precoding matrices whose feedback probabilities exceed a predetermined threshold value.

17. The base station according to claim 12, wherein the subset information generation section updates the precoding matrix subset by selecting M precoding matrices based on feedback information received from the radio communication device.

18. The base station according to claim 12, wherein the subset information generation section selects the M precoding matrices from the N precoding matrices depending on an antenna configuration of the base station.

19. The base station according to claim 12, wherein the feedback information received from the radio communication device includes:
a PMI (Precoding Matrix Indicator), which is information about a precoding matrix providing higher reception quality; and
a BCI (Best Companion Indicator), which is information about a precoding matrix providing lower reception quality.

20. A radio communication system comprising a base station and at least one radio communication device in communication with the base station, wherein the base station comprises:
a subset information generation section which selects M precoding matrices from a predetermined number (N) of precoding matrices to set the M precoding matrices as a precoding matrix subset,
wherein N is an integer equal to or greater than 2 and M is an integer equal to or greater than 1 and equal to or smaller than N;
a transmission section which transmits the precoding matrix subset to the at least one radio communication device; and
a reception section which receives feedback information from the at least one radio communication device,
wherein the at least one radio communication device transmits the feedback information to the base station, and
wherein the feedback information includes information about at least one precoding matrix which is selected from the precoding matrix subset based on reception quality at the at least one radio communication device.

21. A non-transitory computer readable information storage medium storing a program which, when executed by a processor, performs a method comprising:
selecting M precoding matrices from a predetermined number (N) of precoding matrices to set the M precoding matrices as a precoding matrix subset,
wherein N is an integer equal to or greater than 2 and M is an integer equal to or greater than 1 and equal to or smaller than N;
transmitting the precoding matrix subset to a radio communication device; and
receiving, at a base station, feedback information from the radio communication device,
wherein the feedback information includes information about at least one precoding matrix which is selected from the precoding matrix subset based on reception quality at the radio communication device.
